(19) United States
(12) Patent Application Publication
(10) Pub. No.: US 2008/0308074 A1
(43) Pub. Date: Dec. 18, 2008

(54) EVAPORATIVE EMISSIONS CANISTER WITH EXTERNAL MEMBRANE

(76) Inventors: Christopher D. Allen, Eastpointe, MI (US); James T. Dumas, Clinton Township, MI (US); Randy C. Foster, Strafford, MO (US); Donald L. Gepper, Commerce Township, MI (US)

Correspondence Address: Joseph V. Tassone, Esq.;DAYCO PRODUCTS, LLC, 1 Prestige Place, Miamisburg, OH, 45342, US

(21) Appl. No.: 11/762,290

(22) Filed: Jun. 13, 2007

(51) Int. Cl. F02M 33/02

(52) U.S. Cl. 123/519

(57) ABSTRACT

An evaporative emissions system is used in an automotive evaporative emission system including a fuel tank coupled to an automotive engine to control emission of fuel vapors to the atmosphere. The system includes (1) an evaporative emissions canister comprising a unitary molded housing having a circumferential side member, a top member and a bottom member; a hydrocarbon-adsorbing material disposed therein so as to provide a vapor adsorbent chamber for adsorbing hydrocarbon fuel vapor flowing therethrough; and (2) a second housing containing a membrane, the second housing located adjacent the fresh air line of the evaporative emissions canister for preventing fuel vapor molecules and pollutants associated therewith, from passing through the membrane while allowing the air molecules to pass therethrough. A method is provided for preventing or substantially reducing hydrocarbon emissions to the atmosphere.

### BACKGROUND OF THE INVENTION

The present invention relates to a fuel system for an internal combustion engine; particularly, to a method and an evaporation emissions system for preventing or reducing the emission of hydrocarbon pollutants into the atmosphere; and most particularly, to an advanced evaporative emissions canister having a device containing a membrane which acts as a filter media to prevent or reduce the permeation of hydrocarbon fuel to the atmosphere. The device containing the membrane is external with respect to the evaporative emissions canister.

Evaporative emissions result from any one of several events which includes venting of fuel vapors from the fuel tank due to diurnal changes in ambient pressure and/or temperatures (known in the art as “diurnal” emissions or “bleed” emissions), by refueling of the vehicle (known in the art as “refueling” emissions) or by vaporization of fuel by a hot engine and/or exhaust. Generally, the venting of fuel vapor from the fuel tank due to diurnal pressure and/or temperature (diurnal emission), and the escape of fuel vapor during refueling (refueling emissions) are responsible for a majority of the emissions.

Environmental regulations imposed on the automotive industry, by the environmental Protection Agency require that automotive vehicles such as gasoline and diesel powered passenger cars and trucks have on board hydrocarbon emissions controls to prevent or limit the amount of hydrocarbon pollutants expelled into the atmosphere. Such hydrocarbon pollutants are a major contributor to smog formations and contribute to the depletion of the ozone layer in our atmosphere. As a result of government mandates, automotive manufacturers are constantly being challenged to find better and more efficient ways to prevent or reduce the emissions of hydrocarbon fuel vapors and other pollutants into the atmosphere. Such emissions can be controlled by canister systems that employ carbon, preferably activated carbon, to adsorb and hold the hydrocarbon vapors. The adsorbed hydrocarbon vapor is periodically desorbed from the carbon by drawing fresh air into the carbon bed to displace the hydrocarbon fuel vapor. The displaced fuel vapor is then passed to the engine where it is consumed. The renewed carbon can then adsorb additional hydrocarbon fuel vapor from the fuel system by withdrawing the air back out through the vent side of the canister.

Currently, fuel systems employed in the automotive industry employ evaporative emissions canister having an inlet port for receiving fuel vapor from the fuel tank where the fuel vapor is adsorbed on an adsorbent material and stored until such time the stored fuel vapor is returned to the fuel tank or, preferably, directed to the engine where it is consumed. Examples of evaporative emissions canisters are described in a number of U.S. patents and patent applications such as U.S. Pat. Nos. 4,203,401 to Kingsley et al.; 4,658,796 To Yoshida et al.; 4,683,862 to Formuto et al.; 5,119,791 to Gifford, et al.; 5,408,977 to Cotton; 5,924,410 to Dumas et al.; 5,957,114 to Johnson et al.; 6,136,075 to Bragg et al.; 6,237,574 to Jamrog et al.; 6,540,815 to Hiltzik et al.; and RE38, 844 to Hiltzik et al., and U.S. Pat. Appln. Nos. Nos. 2005/0061301 to Meiller; 2005/0123458 to Meiller; and 2006/0065252 to Meiller.

In prior art evaporative emission canisters, the amount of fuel vapor that can be contained in the canister is finite and dependent upon the amount and adsorbent capability characteristics of the adsorbent material contained in the canister. Some prior art canisters employ auxiliary canisters to increase the adsorbent material capacity. The use of additional canisters not only increase the complexity and cost of the evaporative emissions system, but also requires additional space considerations due to the limited space available in the region of the vehicle wherein a canister is installed. Therefore, there is a need in the industry for an evaporative emissions canister which provides increased adsorbent capacity without seriously increasing the complexity, cost and spatial requirements associated with the use of additional canisters and/or filters to achieve the mandated reduction of fuel vapor emissions.

### SUMMARY OF THE INVENTION

It has been found that the emission of hydrocarbon fuel pollutants into the atmosphere during fueling of an automotive vehicle, during diurnal changes in the fuel system, and in the operation of such vehicle, can be substantially reduced or eliminated by integrally incorporating a membrane into a device in the fresh air line of the evaporative emissions canister. The device containing the membrane is installed outside the evaporative emissions canister, which allows significant freedom in determining the most efficient configuration and location of the device in the emissions system.

The membrane useful in the present invention is characterized as a cellular fibular material having physical properties such as pore size, nominal flow path, membrane area and thickness favorable for the separation and trapping of fuel vapor molecules while allowing any air molecules present to flow freely therethrough. Membranes found to be effective in the present invention are available from Amersham Biosciences Membrane Separations Group, W. L. Gore & Associates. The membrane of the present invention not only increases the efficiency of the adsorbent material, but also restricts most of the hydrocarbon molecules associated with fuel vapor from permeating the membrane and escaping into the atmosphere, while allowing clean air molecules to pass through the membrane. Typically, the membrane is effective to prevent substantially all of the fuel vapor from passing therethrough while allowing substantially all of the air molecules to pass therethrough. More typically, the membrane prevents greater than about 80% of the fuel vapor molecules from passing through the membrane while allowing greater than about 95% of the air molecules to pass therethrough. Most typically, the membrane prevents greater than about 95% of the fuel vapor molecules from passing through the membrane while allowing greater than about 99% of the air molecules to pass therethrough and be expelled to the atmosphere.

Accordingly, it is a primary object of this invention to provide an improved evaporative emissions system, which incorporates a membrane in a housing separate from the evaporative emissions canister wherein the full capacity of the adsorbent material can be effectively utilized.

It is another object of the invention to provide an evaporative emissions canister that provides reduced fuel emissions to the atmosphere.

It is still another object of the invention to optimize the overall packaging of the evaporative emissions system by allowing the membrane housing to be more efficiently configured and located in the emissions system.

It is yet another object of the invention to provide all of the above objects of the invention without complexity and economic considerations.

These objects as well as other objects, features and advantages of the present invention will be apparent to those skilled in the art from the following detailed description, appended claims and accompanying drawings.

### BRIEF DESCRIPTION OF THE DRAWINGS

FIG. 1 is a side view of an evaporative emission system in accordance with a first embodiment of the present invention;

FIG. 2 is a side view of an evaporative emissions system in accordance with a second embodiment of the present invention;

FIG. 3 is a perspective view of an auxiliary canister housing a membrane in accordance with the present invention; and

FIG. 4 is a perspective view of the auxiliary canister of the present invention having a cut-a-way portion showing the membrane in the container.

### DETAILED DESCRIPTION OF THE INVENTION

According to the invention, an evaporative emissions canister such as that described in commonly assigned U.S. patent application Ser. No. 11/592,973, filed Nov. 3, 2006, the contents of which are incorporated herein by reference thereto, can be effectively employed to not only reduce the amount of fuel vapor pollutants such as nitrogen oxides, sulfur oxides, etc. into the atmosphere, but to substantially improve the efficiency of the adsorbent material in the evaporative emissions canister by installing a separate housing member containing a membrane wherein the separate housing is installed outside the evaporative emissions canister. In a typical installation, the device is placed in the fresh air line where the membrane permits the free flow of air without obstruction from the atmosphere to the evaporative emissions canister during a purge step, and from the evaporative emissions canister to the atmosphere during a regeneration step, while preventing the emission of hydrocarbon fuel vapors and pollutants into the atmosphere.

In addition to the afore-mentioned physical properties necessary for the sufficient separation of fuel vapor molecules from fresh air molecules in the evaporative emissions system, there are other properties that affect mass transfer during gas separation through a membrane. Such additional properties include:
Mobility Selectivity—It retards the movement of one species while allowing the movement of the other species. This is done by controlling the size distribution of the network of available passages (pores) to favor one of the components relative to the rest.
Solubility Selectivity—Selectivity is also determined by the relative sorptivity of the mixture components. Normal boiling point of mixture components is a good indicator of solubility selectivity. The higher the boiling point of a species, the more condensable is the gas and therefore higher is sorptivity.
Transport Plasticization—Due to the presence of a penetrant, the size range of transient gaps tends to be less sharply controlled and therefore mobility selectivity begin to fall. Therefore, interaction between mixture components and membrane material is important.
Operating Temperature—Higher temperature increases molecular diffusivity and less size-discriminating gaps in the polymer matrix. Therefore, permeability increases and selectivity decreases.

### Reference: R. W Baker, E. L. Cussler, W. Eykamp, W. J. Koros, R. L. Riley and H. Strathmann, Membrane Separation Systems Recent Developments and Future Directions, Chap 3, vol. 11, pp. 189-241, Noyes Data Corp, New Jersey, USA, 1991.

The membrane employed in the present invention effectively prevents or reduces the permeation of fuel vapor molecules through the membrane while allowing air molecules to pass freely therethrough. More specifically, the evaporative emissions canister of the present invention incorporates the membrane externally with respect to the canister and more specifically externally on the vent or fresh air side of the evaporative emissions canister at the vent or fresh air inlet/outlet port. By installing the membrane externally at the vent or fresh air inlet/outlet port, the membrane prevents the permeation of the hydrocarbon fuel vapor through the membrane, thereby allowing the entire adsorbent bed to be utilized for adsorbing fuel vapor as opposed to prior canisters which effectively utilize only a fraction of the adsorbent material contained in the canister for the adsorption of the fuel vapor. A considerable amount of the adsorbent material is used as a buffer on the vent side of the canister. Accordingly, prior devices effectively utilize only about one-half to two-thirds of the capacity of the adsorbent bed. As more fully described below, the evaporative emissions canister of the present invention which utilizes a membrane on the vent or fresh air side of the canister provides a more effective and more efficient device for preventing or reducing the emission of fuel vapor into the atmosphere.

The canister device of the present invention may be of any physical configuration and dimension employed in the art for the prevention or reduction of hydrocarbon emissions into the atmosphere. However, for the purpose of illustration, the automotive evaporative emissions canister comprises:

a first housing having a circumferential side member having an inner surface and an outer surface, a top member having an inner surface and an outer surface and a bottom member having an inner surface and an outer surface, wherein the inner surface of said circumferential side member, the inner surface of the top member and the inner surface of the bottom member form a first chamber for receiving fuel vapor from a fuel tank and a second chamber containing a fuel vapor-adsorbent material for adsorbing the fuel vapor from the fuel tank;

a partition extending vertically downwardly from the inner surface of the top member, wherein the partition divides the second chamber containing the fuel vapor-adsorbent material into a first compartment and a second compartment;

a first tubular member extending upwardly from the housing and in operable communication with the fuel vapor-receiving chamber, the first tubular member providing a passage through which the fuel vapor flows into the fuel vapor-receiving chamber;

a first port in the housing, the first port providing open communication between the housing and the first tubular member;

a second tubular member extending upwardly from the housing and in operable communication with the fuel-receiving chamber, the second tubular member providing a passage through which fuel vapor flows from the evaporative emissions canister to an automotive engine where the fuel vapor is consumed;

a second port in the housing, the second port providing open communication between the fuel vapor receiving chamber and said second tubular member;

a third tubular member extending upwardly from the housing, the third tubular member providing a passage through which fresh air is admitted to the second chamber during a purging step, and through which air from an air/fuel mixture is vented to the atmosphere in a venting step; and

a third port in the housing, the third port providing open communication between the fuel vapor adsorbent chamber and the third tubular member, and

an auxiliary housing containing a membrane, wherein the auxiliary housing containing the membrane is disposed in the fresh air line outside the confines of the evaporative emissions canister.

As described in the aforementioned copending U.S. patent application Ser. No. 11/572,973, the fuel vapor from the fuel tank may contain a small amount of liquid fuel entrained along with the fuel vapor. If such liquid fuel is allowed to contact the adsorbent material in the evaporative emissions canister, the effectiveness of the adsorbent material may be severely diminished. Therefore, the canister of the aforementioned copending application contains provisions for a liquid-fuel trap to be integrally incorporated into the canister directly above the adsorbent chamber. Such canister would find similar utility in the present application.

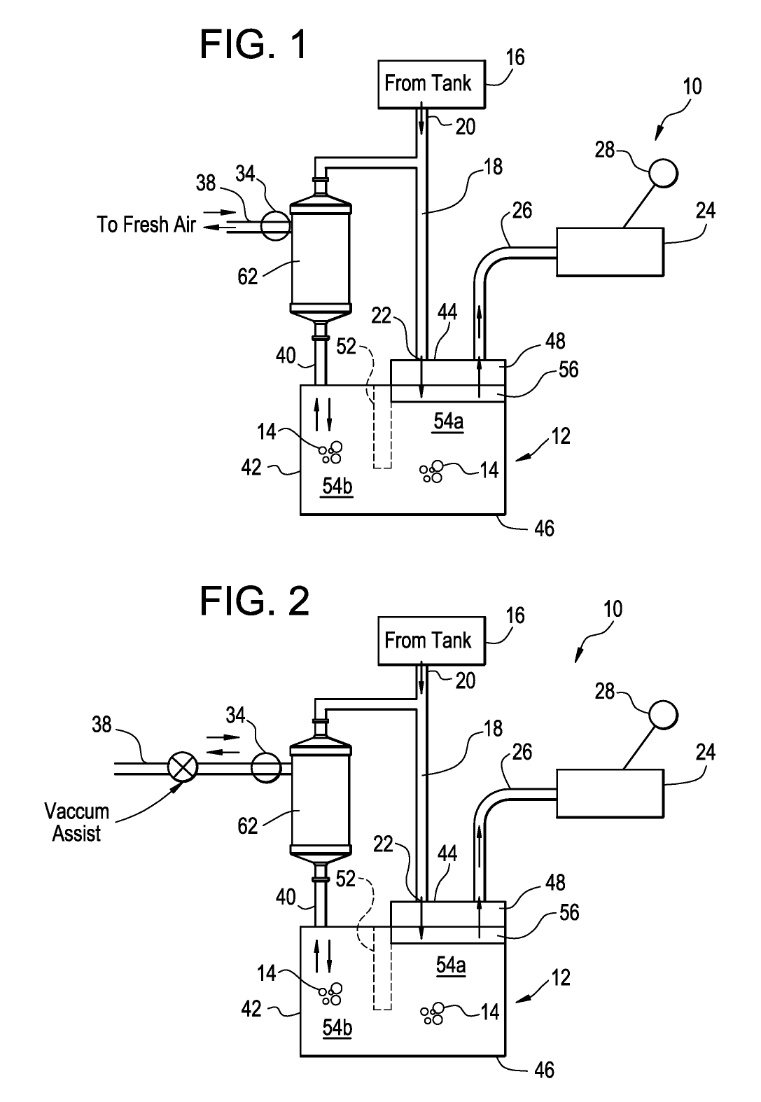

Turning now to the drawings, FIG. 1, the evaporative emissions system of the present invention includes an evaporative emissions canister 12 containing a bed of adsorbent material 14. Fuel vapor vented from the fuel tank 16 flows through the fuel vapor line 18 which communicates with fuel tank 16 via port 20 and with canister 12 via port 22. The fuel vapor is vented from the fuel tank 16 where it flows through fuel vapor line 18 to the canister 12, where the fuel vapor is adsorbed on the bed of adsorbent material 14. The adsorbed fuel vapor is then purged from the adsorbent material 14 as necessary by applying engine vacuum on the bed of adsorbent material 14, drawing fresh air from the atmosphere and through the adsorbent material 14 to displace the fuel vapor. The displaced fuel vapor is then fed to the engine 24 through engine vacuum line 26, and consumed during a purge step.

When the adsorbent material 14 becomes saturated with the fuel vapor, engine controller 28 commands fuel vapor valve 30 to close the fuel vapor load line 18 and the fuel vapor is desorbed from the adsorbent material 14 and drawn by vacuum through an engine vacuum controller 28 connecting engine vacuum line 26 to the engine 24 where the desorbed fuel vapor is consumed. A vacuum is created by opening the fresh air valve 34 causing fresh air from the atmosphere to be drawn into the canister 12 through a membrane 36 (FIG. 4) disposed in an auxiliary canister 64 located in the fresh air line 38 outside the evaporative emissions canister 12.

As shown in FIGS. 1 and 2, an evaporative emissions canister 12 includes a housing having a side member 42, a top member 44 and a bottom member 46. The canister 12 further includes a fuel vapor-receiving chamber 48 located above the adsorbent chamber 50. The adsorbent chamber 50 includes a partition 52 that divides the adsorbent chamber into two compartments 54a and 54b, both of which contain adsorbent material 14. The adsorbent material 14 in the first compartment 54a, which is located directly below the fuel vapor-receiving chamber 48, adsorbs and stores the fuel vapor as it enters the compartment 54a. During a purge step, the fuel vapor valve (not shown) is actuated to draw fresh air from the fresh air valve 34 (not shown) through the second compartment 54b via fresh air port 40 where the fresh air travels through the adsorbent material 14 and around the bottom of the partition 52 displacing the fuel vapor adsorbed and stored in the compartment 54a. The displaced fuel vapor proceeds to the automotive engine 26 through engine vacuum line 26, where it is consumed. Fuel vapor entering the canister 14 through port 22 is passed into the adsorbent chamber 50, which contains the adsorbent material 14.

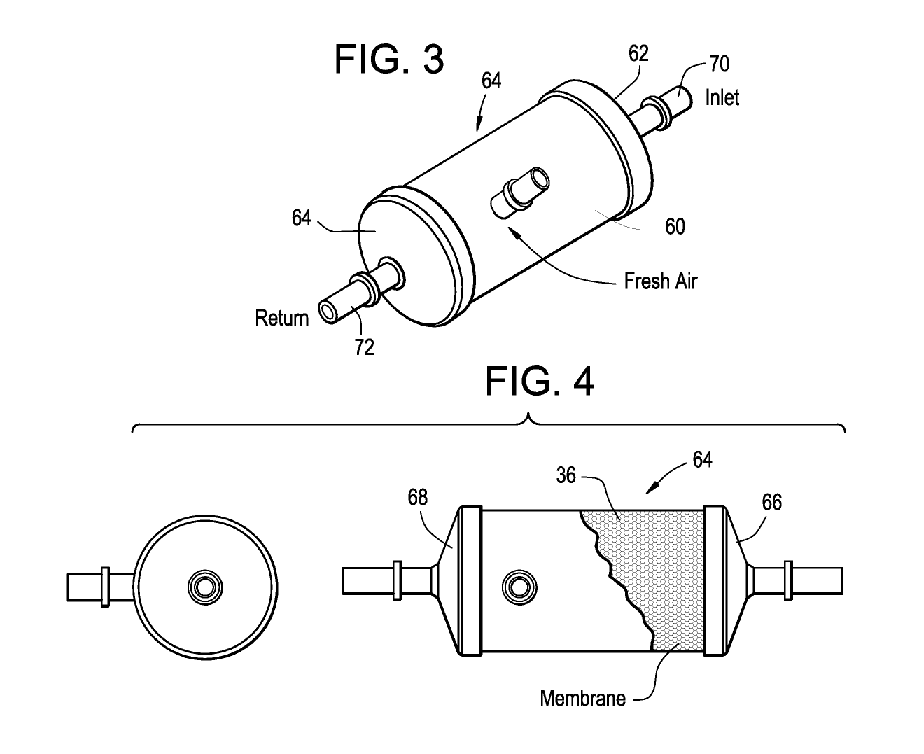

FIG. 3 shows an auxiliary canister 62 in accordance with the invention. The auxiliary canister 62 has a continuous side member 68, a first end member 64 and a second end member 66 opposite the first end member 62. The auxiliary canister 62 may be formed with one closed end as an integral member and the other end formed openly to provide access to the interior of the auxiliary canister 62. Once the membrane 36 is disposed inside the auxiliary canister 62, the second end is secured to the auxiliary canister 62 by a securing means such as a threaded coupling, clamp, interlocking means, and the like. Each of the first and second end members has a tubular member 70 and 72, respectively, along the longitudinal axis of the auxiliary canister 62. In addition there is a third tubular member 74 extending laterally form the side of the auxiliary canister 62 for transporting fresh air to the auxiliary canister 62 during a purge step, and for transporting air to the atmosphere during a venting step. Each of the tubular members 70, 72 and 74 is secured to the auxiliary 62 by securing means, such as a quick connect/disconnect securing means. The auxiliary canister 36 containing the membrane 36 is connected to canister 12 via fresh air port 40. Upon removal of the fuel vapor from the adsorbent material 14, the fuel vapor valve is opened so that additional fuel vapor from the fuel tank 16 can be transported via fuel vapor load line 18 to the canister 12 where it is adsorbed on the renewed adsorbent material 14. At the same time the air is forced back through the adsorbent material 14, through the auxiliary canister 62 containing the membrane 36 at the fresh air port 40, and through the fresh air line 38 on to the atmosphere. The fresh air valve 34 is opened and closed by the engine controller 28 allowing fresh air to enter the canister 14 during the purging step and to allow fresh air to exit the canister 12 and the auxiliary canister 62 during the adsorption step. However, the fresh air valve 34 typically remains open until routine or diagnostic steps are performed on the automotive vehicle. The auxiliary housing 64 containing the membrane 36 is connected to canister 12 via fresh air port 40.

In order to keep the adsorbent material 14 inside the adsorbent chamber 50, a barrier member 56 may be disposed between the fuel vapor-receiving chamber 48 and the adsorbent chamber 50 to keep the adsorbent material 14 from inadvertently escaping the adsorbent chamber 50 and entering the fuel vapor-retaining chamber 48. Typically the barrier member 56 is a porous material such as a foamed polymeric material, a fibrous material, or the like. Typically, a relatively rigid support member having one or more apertures therein to allow the fuel vapor to flow therethrough is disposed between the fuel vapor receiving chamber and the adsorbent chamber. The bottom surface of the support member includes a plurality of finger elements extending downwardly from the bottom surface of the barrier member. The finger elements interconnect with the barrier member to provide the barrier member with a relatively flat surface having increased surface area. A barrier layer and a support member similar to that discussed above may be place between the adsorbent material in compartment 54a and the fresh air port 40.

As described in the aforementioned copending U.S. patent application Ser. No. 11/572,973, the fuel vapor from the fuel tank may contain a small amount of liquid fuel entrained along with the fuel vapor. If such liquid fuel is allowed to contact the adsorbent material in the evaporative emissions canister, the effectiveness of the adsorbent material may be severely diminished. Therefore, the canister of the aforementioned copending application contains provisions for a liquid-fuel trap to be integrally incorporated into the canister directly above the adsorbent chamber. Such canister would find similar utility in the present application. In those instances where liquid fuel is entrained with the fuel vapor into the evaporative emissions canister, such liquid fuel may be separated from the fuel vapor by a liquid-fuel trap where such liquid fuel remains until it is evaporated and passed on the engine along with the desorbed fuel vapor from the adsorbent material where it is consumed. A more detailed description of a liquid fuel trap is set forth in the aforementioned copending U.S. patent application Ser. No. 11/572,973.

The evaporative emissions canister of the present invention is manufactured from any material possessing the desirable properties and characteristics, such as flexibility, fuel resistance, heat resistance, pressure resistance, weatherability, dimensional stability, and high impact strength. Typically, such material is a polymeric material, more preferably, a polyamide material such as nylon, an aromatic polyamide such as aramid or a polyolefin such as polyethylene.

Typically, the evaporative emissions canister, including the various parts thereof, is molded in one piece to provide a continuous unitary structure thereby preventing the need for any assembly steps.

The adsorbent material useful in the invention may be any of the conventional materials effective to adsorb hydrocarbon materials such as fuel vapor. Preferable, the adsorbent material is carbon and most preferably activated carbon. The carbon can be in any desired form having an effective particle size sufficient to maximize the absorbance of the fuel vapor in the canister.

Typically, the evaporative emissions canister will include a volume compensator, as is well known in the art, located at the bottom of the canister housing to limit shifting of the adsorbent material during operation of the automotive vehicle.

While the present invention has been fully illustrated and described in detail, other designs, modifications and improvements will become apparent to those skilled in the art. Such designs, modifications and improvements are considered to be within the spirit of the present invention, the scope of which is determined only by the scope of the appended claims.

What is claimed is:

1. An automotive evaporative emissions canister for preventing or reducing the emission of residual fuel vapor, from a vent side of said automotive evaporative emissions canister, into the atmosphere, said canister comprising:
a first housing including a circumferential side member having an inner surface and an outer surface, a top member having an inner surface and an outer surface, and a bottom member having an inner surface and an outer surface;
a first partition extending vertically from said inner surface of said top member, wherein said partition divides said housing into a first compartment and a second compartment;
a first tubular member extending from said housing and in operable communication with said first compartment, the first tubular member providing a passage through which said fuel vapor flows into said first compartment;
a first port in operable communication with said first compartment, said first port providing a passageway through which fuel vapor flows into said first compartment;
a second tubular member extending from said housing and in operable communication with said first compartment providing a passageway through which fuel vapor, desorbed from said fuel adsorbent material, flows from said first compartment to an automotive engine where said fuel vapor is consumed during a purge step;
a second port in operable communication with said housing, said second port providing a passageway through which fuel vapor flows from said evaporative emissions canister to said second tubular member;
a third tubular member extending from said housing, said third tubular member providing a passage through which fresh air is admitted to said second compartment during a purging step, and through which air from an air/fuel mixture is vented to said atmosphere in a venting step; and
a third port in operable communication with said second compartment, said third port providing a passageway through which air is admitted to said second chamber upon desorption of said fuel vapor during a purging stage and for venting said air/fuel vapor through said third port to the atmosphere during a venting stage; and
an auxiliary housing containing a membrane, said auxiliary housing being disposed externally with respect to said first housing at said fresh air line and in operable communication with said third port, wherein said membrane prevents or reduces fuel vapor from escaping into the atmosphere.

2. The canister of claim 1 wherein said membrane is characterized as a cellular fibrous or polymeric material having physical properties sufficient to effectively cause any residual fuel vapor molecules to be sufficiently filtered or separated on said membrane while allowing fresh air molecules to pass freely therethrough.

3. The canister of claim 2 wherein said membrane prevents greater than about 95% of the fuel vapor molecules including pollutants from the vapor to be emitted to the atmosphere while allowing substantially all of the air molecules to pass freely therethrough.

4. The canister of claim 1 wherein each of said first housing and said second housing is a unitary structure molded from a material exhibiting sufficient flexibility, fuel resistance, heat resistance, pressure resistance, weatherability, dimensional stability, and high impact strength to withstand a harsh environment associated with an automotive evaporative emissions system.

5. The canister of claim 4 wherein said each of said first housing and said second housing is molded from a polyamide or a polyolefin.

6. The canister of claim 5 wherein each of said first housing and said housing is molded from nylon.

7. The canister of claim 1 wherein said fuel vapor-adsorbent material comprises carbon.

8. The canister of claim 7 wherein said carbon is activated carbon.

9. The canister of claim 1 further comprising a second partition separating said first compartment into a first cavity for receiving said fuel vapor from said fuel tank and a second cavity containing said fuel vapor adsorbent material.

10. The canister of claim 9 further comprising a liquid-fuel vapor trap disposed in said first cavity for trapping and storing liquid fuel entrained along with said fuel vapor from said fuel tank

11. In an automotive evaporative emission system comprising:
a housing including a circumferential side member having an inner surface and an outer surface, a top member having an inner surface and an outer surface, and a bottom member having an inner surface and an outer surface;
a first partition extending vertically from said inner surface of said top member, wherein said partition divides said housing into a first compartment and a second compartment;
a first tubular member extending from said housing and in operable communication with said first compartment, the first tubular member providing a passage through which said fuel vapor flows into said first compartment;
a first port in operable communication with said first compartment, said first port providing a passageway through which fuel vapor flows into said first compartment;
a second tubular member extending from said housing and in operable communication with said first compartment providing a passageway through which fuel vapor, desorbed from said fuel adsorbent material, flows from said first compartment to an automotive engine where said fuel vapor is consumed during a purge step;
a second port in operable communication with said housing, said second port providing a passageway through which fuel vapor flows from said evaporative emissions canister to said second tubular member;
a third tubular member extending from said housing, said third tubular member providing a passage through which fresh air is admitted to said second compartment during a purging step, and through which air from an air/fuel mixture is vented to said atmosphere in a venting step; and
a third port in operable communication with said second compartment, said third port providing a passageway through which air is admitted to said second chamber upon desorption of said fuel vapor during a purging stage and for venting said air/fuel vapor through said third port to the atmosphere during a venting stage including a fuel tank coupled to an automotive engine wherein the evaporative emissions system includes an evaporative emissions canister having a fuel adsorbent compartment containing a fuel adsorbent material to control emission of fuel vapors to the atmosphere, the improvement wherein said evaporative emissions canister comprises an auxiliary housing containing a membrane, said auxiliary housing being disposed externally with respect to said first housing at said fresh air line and in operable communication with said third port, wherein said membrane prevents or reduces fuel vapor from escaping into the atmosphere.

12. The system of claim 11 wherein said membrane is characterized as a cellular fibular material having physical properties sufficient to effectively cause any fuel vapor component molecules to be sufficiently filtered or separated on the membrane while allowing fresh air molecules to pass freely therethrough.

13. The system of claim 12 wherein said membrane filters or separates substantially all of the fuel vapor molecules including pollutants from the vapor to be emitted to the atmosphere while allowing substantially all of the air molecules to pass freely therethrough.

14. The system of claim 12 wherein said membrane filters or separates greater than about 95% of the fuel vapor molecules including pollutants from the vapor to be emitted to the atmosphere while allowing substantially all of the air molecules to pass freely therethrough.

15. The canister of claim 11 further comprising a liquid-fuel vapor trap disposed therein for trapping and storing liquid fuel entrained along with said fuel vapor from said fuel tank.

16. A method for preventing or reducing emission of fuel by-products from an automotive vehicle into the atmosphere, said method comprising:
(1) Providing an evaporative emissions canister between a fuel tank and an internal combustion engine, wherein said evaporative emissions canister comprises:
(a) a housing having a circumferential side member having an inner surface and an outer surface, a top member having an inner surface and an outer surface and a bottom member having an inner surface and an outer surface, wherein said inner surface of said circumferential side member, said inner surface of said top member and said inner surface of said bottom member form a chamber for receiving fuel vapor from a fuel tank containing a fuel vapor-adsorbent material for adsorbing said fuel vapor from said fuel tank;
(b) a partition extending vertically from said inner surface of said top member, wherein said partition divides said chamber into a first compartment having said fuel adsorbent disposed therein for adsorbing said fuel vapor from said fuel tank and a second compartment for expelling air to the atmosphere during a venting step and for receiving fresh air during a purge step;
(c) a first port in said housing and in operable communication with said first chamber, said first port providing a passageway through which fuel vapor flows into said first chamber;
(d) a first tubular member operatively connected to said first port through which fuel vapor flows into said first chamber;
(e) a second port in said housing and in operable communication with said second chamber, said second port providing a passageway through which fuel vapor flows from said evaporative emissions canister to an automotive engine where said fuel vapor is consumed;
(f) a second tubular member operatively connected to said second port through which fuel vapor flows from said evaporative emissions canister to an automotive engine where said fuel vapor is consumed during a purge step;
(g) a third port extending in said housing and in operable communication with said second compartment, said third port providing a passageway through which air is admitted to said second compartment upon desorption of said fuel vapor during a purging stage and for venting said air to the atmosphere during a venting stage; and
(h) a second tubular member operatively connected to said second port through which fuel vapor flows from said evaporative emissions canister to an automotive engine where said fuel vapor is consumed during a purge step; and
(2) providing a second housing having disposed therein a membrane, wherein said membrane prevents or substantially reduces fuel vapor from escaping into the atmosphere through said third port, and
(3) installing said second housing in said second compartment of said evaporative emissions canister adjacent said inner surface of said top member and in operable communication with said third port wherein said membrane, sequentially, provides free flow of fresh air from the atmosphere to the evaporative emissions canister during a purge step wherein fuel vapor is desorbed from said adsorbent material in said evaporative emissions canister, and providing a free flow of a air/residual fuel vapor mixture from said evaporative emissions canister to the atmosphere in a vent step, said membrane separating said residual fuel vapor from said air/fuel vapor mixture and returning said fuel vapor to said evaporative emissions canister.

17. The method of claim 16 wherein said membrane is characterized as a cellular fibular material having physical properties sufficient to effectively cause any fuel vapor component molecules to be sufficiently filtered or separated on the membrane while allowing fresh air molecules to pass freely therethrough.

18. The method of claim 17 wherein said membrane filters or separates substantially all of the fuel vapor molecules including pollutants from the vapor to be emitted to the atmosphere while allowing substantially all of the air molecules to pass freely therethrough.

19. The method of claim 17 wherein said membrane filters or separates greater than about 95% of the fuel vapor molecules including pollutants from the vapor to be emitted to the atmosphere while allowing substantially all of the air molecules to pass freely.

20. The method of claim 16 further comprising a liquid-fuel vapor trap disposed therein for trapping and storing liquid fuel entrained along with said fuel vapor from said fuel tank.
